(19) United States
(12) Patent Application Publication
(10) Pub. No.: US 2013/0052843 A1
(43) Pub. Date: Feb. 28, 2013

(54) ELECTRICAL CONNECTOR HAVING ELECTRICALLY INSULATIVE HOUSING AND COMMONED GROUND CONTACTS

(71) Applicants: Douglas M. Johnescu, York, PA (US); Jonathan E. Buck, Hershey, PA (US)

(72) Inventors: Douglas M. Johnescu, York, PA (US); Jonathan E. Buck, Hershey, PA (US)

(73) Assignee: FCI Americas Technology LLC, Carson City, NV (US)

(21) Appl. No.: 13/519,419

(22) PCT Filed: Dec. 17, 2010
(86) PCT No.: PCT/US10/61010

§ 371 Date: Oct. 4, 2012

Related U.S. Application Data
(60) Provisional application No. 61/291,015, filed on Dec. 30, 2009.

(51) Int. Cl. H01R 13/648

(52) U.S. Cl. 439/95

(57) ABSTRACT

An electrical connector is provided having an electrically insulative connector housing that supports a plurality of signal contacts, as well as a plurality of ground contact networks. The ground contact networks include a conductive ground coupling bar supporting a plurality of ground contacts along a pair of columns that are spaced apart along a row direction.

### CROSS-REFERENCE TO RELATED APPLICATIONS

### Background

Electrical connectors typically include a plurality of signal contacts and ground contacts. Often, the signal contacts are so closely spaced that undesirable interference, or “cross talk,” occurs between adjacent signal contacts. Cross talk occurs when one signal contact induces electrical interference in an adjacent signal contact due to intermingling electrical fields, thereby compromising signal integrity. With electronic device miniaturization and high speed, high signal integrity electronic communications becoming more prevalent, the reduction of cross talk becomes a significant factor in connector design.

### SUMMARY

In accordance with one embodiment, an electrical connector includes an electrically insulative connector housing, a plurality of signal contacts supported by the connector housing, and a ground contact network. The ground contact network includes an electrically conductive ground coupling bar defining first and second opposed sides, and a plurality of ground contacts mounted to the first and second sides of the ground coupling bar in first and second respective columns. The ground coupling bar places each of the plurality of ground contacts mounted to the first side in electrical communication with each other, further places each of the plurality of ground contacts mounted to the second side in electrical communication with each other, and further places each of the plurality of ground contacts mounted to the first side in electrical communication with each of the plurality of ground contacts mounted to the second side. The electrically conductive ground coupling bar helps to reduce crosstalk between differential signal pairs along the respective columns, and helps to reduce crosstalk between differential signal pairs in a direction perpendicular to the columns.

### BRIEF DESCRIPTION OF THE DRAWINGS

The foregoing summary, as well as the following detailed description of a preferred embodiment, are better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1A is a perspective view of an electrical connector constructed in accordance with one embodiment, including a connector housing supporting a plurality of electrical signal and ground contacts;

FIG. 1B is a top plan view of the connector housing illustrated in FIG. 1A;

FIG. 1C is an assembly view of the electrical connector illustrated in FIG. 1A, further showing a plurality of ground contact networks;

FIG. 2 is a perspective view of a pair of the ground contact networks illustrated in FIG. 1C, each including a ground coupling bar and a plurality of ground contacts;

FIG. 3A is a perspective view of one of the ground coupling bars illustrated in FIG. 2;

FIG. 3B is a side elevation view of the ground coupling bar illustrated in FIG. 3A;

FIG. 4A is a first perspective view of one of the ground contacts illustrated in FIG. 2;

FIG. 4B is a second perspective view of one of the ground contacts illustrated in FIG. 2;

FIG. 5A is an assembly view of one of the ground contact networks illustrated in FIG. 2;

FIG. 5B is another assembly view of the ground contact network illustrated in FIG. 5A;

FIG. 6 is a sectional end elevation view of the electrical contact illustrated in FIG. 4A, taken along line 6-6;

FIG. 7A is a perspective view of the pair of ground contact networks illustrated in FIG. 2, along with an auxiliary ground coupling bar configured to electrically connect the ground contacts of the ground contact networks;

FIG. 7B is an assembly view of the pair of ground contact networks and the auxiliary ground coupling bar illustrated in FIG. 7A;

FIG. 8A is a perspective view of the auxiliary ground coupling bar illustrated in FIG. 7A;

FIG. 8B is a side elevation view of the auxiliary ground coupling bar illustrated in FIG. 8A;

FIG. 9 is a perspective view of one of the electrical contacts illustrated in FIG. 7A; and

FIG. 10 is a schematic illustration of a footprint defined by the array of electrical contacts illustrated in FIG. 1.

### DETAILED DESCRIPTION

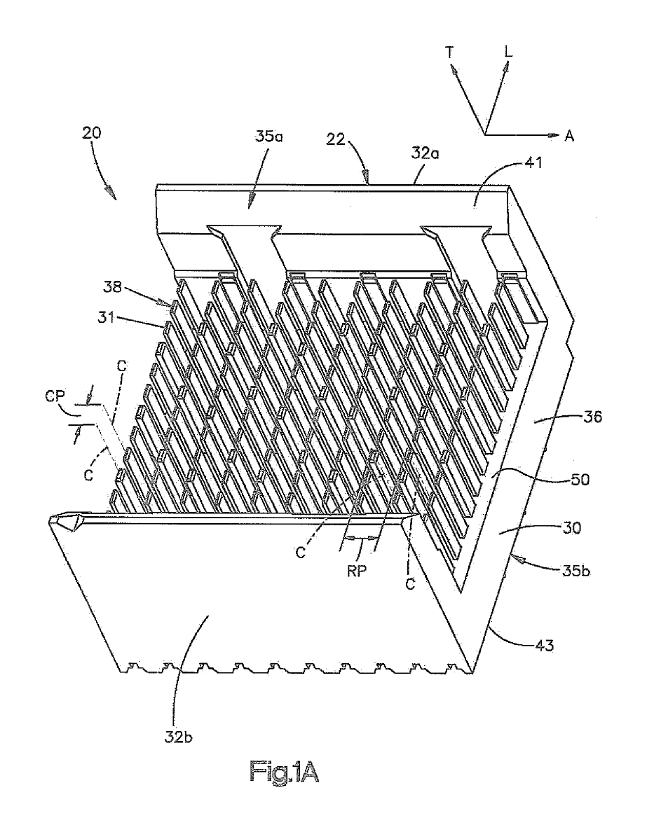

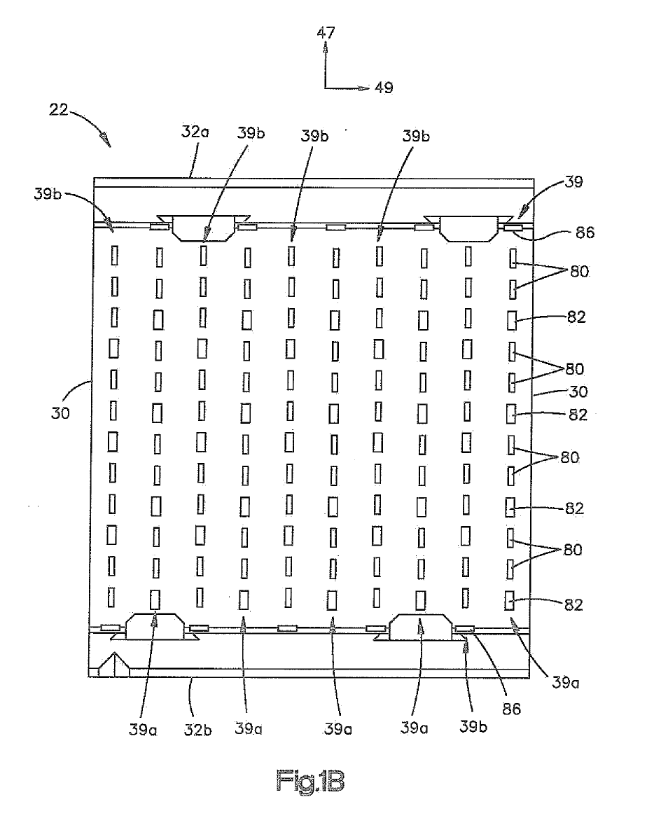

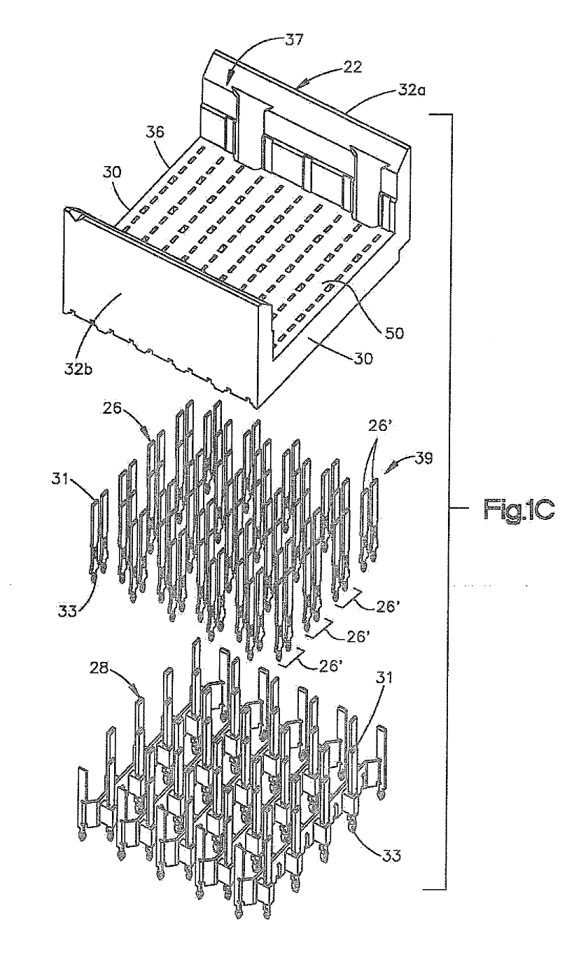

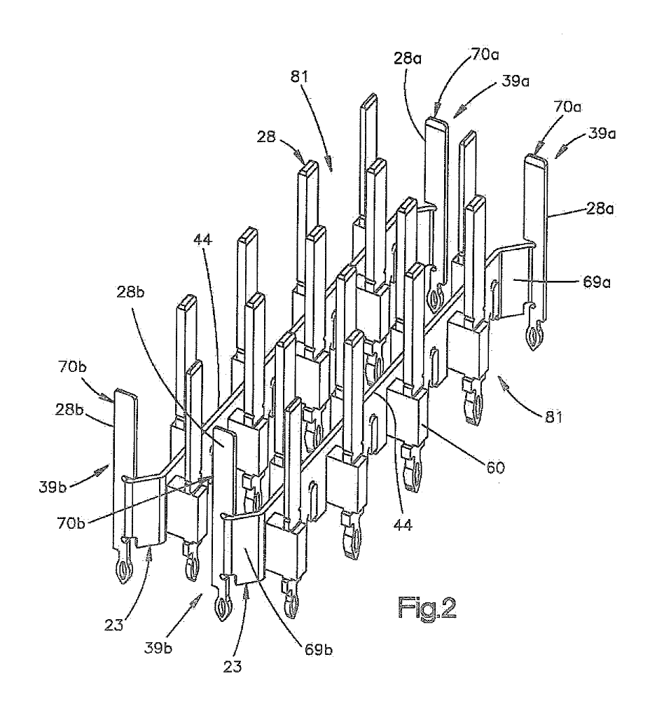

Referring to FIGS. 1A-2, an electrical connector 20 includes a dielectric or electrically insulative connector housing 22 and a plurality of electrical contacts 38. The connector housing 22 can be made from a dielectric plastic or any suitable alternative material, and defines a frame 36 including a first end wall 32a and a second opposed end wall 32b spaced from the first end wall 32a along a longitudinal direction L, a pair of opposed side walls 30 that are spaced apart along a lateral direction A that is substantially perpendicular to the longitudinal direction L, and are connected between the first and second end walls 32a-b so as to define a contact receiving space 37. The connector housing 22 further defines a top end 35a and an opposed bottom end 35b spaced from the top end 35a along a transverse direction T that is substantially perpendicular with respect to the longitudinal direction L and the lateral direction A. In accordance with the illustrated embodiment, the transverse direction T is oriented vertically, and the longitudinal and lateral directions L and A are oriented horizontally, though it should be appreciated that the orientation of the electrical connector 20 may vary during use. Thus, the electrical connector 20 and its components are described herein in the illustrated orientation, it being appreciated that the actual orientation of the electrical connector 20 can vary during use. In accordance with the illustrated embodiment, the end walls 32a-b extend upward from the side walls 30.

The connector housing 22 further includes a support wall 50 that supports the electrical contacts 38. The support wall 50 can be disposed proximate to the lower end 35b as illustrated, or can alternatively be located anywhere on the connector housing 22 as desired. It should be appreciated that the connector housing 22 can include the support wall 50 which can be integral with the connector housing 22 or otherwise discreetly connected to the side walls 32a and 32b, such that the support wall 50 can be made of the same electrically insulative material as the remainder of the connector housing 22. The electrical connector 20 defines a mating interface 41 disposed proximate to the top end 35a and a mounting interface 43 disposed proximate to the bottom end 35b. The electrical connector 20 is configured to be mounted to a complementary electrical component, such as a complementary substrate or printed circuit board, at the mounting interface 43, and is configured to mate with a complementary electrical component, such as a complementary electrical connector, at the mating interface 41.

The electrical connector 20 includes a plurality of electrical contacts 38 that are carried by the connector housing 22 and are at least partially disposed in the contact receiving space 37. The electrical contacts 38 each define respective mating ends 31 and opposed respective mounting ends 33 spaced from the mating ends 31 along the transverse direction T. The mating ends 31 are disposed proximate to the mating interface 41, and are configured to mate with complementary electrical contacts of the complementary electrical component, such as the complementary electrical connector. The mounting ends 33 are disposed proximate to the mounting interface 43, and are configured to electrically connect with complementary electrical traces of the complementary electrical component, such as the complementary substrate or printed circuit board. The mounting ends 33 can define press-fit terminals, surface mounted terminals, or any alternative terminal suitable for connection to the complementary electrical component. In accordance with the illustrated embodiment, the ground contacts 28 each define a ground contact body 57, such that the mounting ends 33 extend down from the contact body 57.

The mounting ends 33 of the electrical contacts 38 are configured to electrically connect with electrical traces of an underlying substrate or printed circuit board when the electrical connector 20 is mounted to the underlying printed circuit board, and the mating ends 31 are configured to electrically connect to complementary electrical contacts of the electrical device to which the electrical connector 20 is mated. Thus, the electrical connector 20 is configured to place the printed circuit board to which the electrical connector 20 is mounted in electrical communication with the complementary electrical device to which the electrical connector 20 is mated.

The mating ends 31 can be configured as blades that are configured to be received in complementary receptacles of the complementary electrical contacts. Thus, the electrical contacts 38 can be referred to as header contacts. Alternatively, the electrical contacts 38 can be configured as receptacle contacts whose mating ends 31 are configured to receive complementary header contacts, or hermaphroditic contacts as desired.

Furthermore, in accordance with the illustrated embodiment, the mating interface 41 is oriented substantially parallel to the mounting interface 43, such that the electrical connector 20 can be referred to as a vertical electrical connector. Alternatively, the electrical connector 20 can be configured as a right-angle electrical connector whereby the mating interface 41 is oriented substantially perpendicular with respect to the mounting interface 43. Likewise, in accordance with the illustrated embodiment, the mating ends 31 are oriented substantially parallel to the mounting ends 33, such that the electrical contacts 38 can be referred to as vertical electrical contacts. Alternatively, the electrical contacts 38 can be configured as right-angle electrical contacts whereby the mating ends 31 are oriented substantially perpendicular with respect to the mounting ends 33.

In accordance with the illustrated embodiment, the electrical contacts 38 can include at least one signal contact 26 such as a plurality of signal contacts 26, and at last one ground contact 28 such as a plurality of ground contacts 28 that can be arranged as desired along respective columns 39 that extend along a longitudinal column direction 47. The columns 39 are spaced apart along a lateral row direction 49 that is angularly offset, such as perpendicular, with respect to the column direction 47. The electrical connector 20 can define a column pitch CP, which is a distance along the column direction 47 between centerlines C of adjacent electrical contacts 38 along the column direction 47. The centerlines C are centrally disposed along the contact body 57 between the mating ends 31 and the mounting ends 33. The electrical connector 20 can further define a row pitch RP, which is a distance between centerlines C of adjacent electrical contacts 38 along the row direction 49. The electrical connector 20 can define as many rows and columns of electrical contacts 38 as desired, such that the electrical contacts 38 are equidistantly spaced along the column and row directions 47 and 49.

In accordance with the illustrated embodiment, adjacent pairs of signal contacts 26 along a respective column 39 can define differential signal pairs 26′. Alternatively, the signal contacts 26 can be single-ended. The ground contacts 28 can be disposed adjacent a signal contact 26, and can be disposed between adjacent signal contacts 26. For instance, the ground contacts 28 can be disposed between adjacent pairs of differential signal pairs 26′. Accordingly, a given ground contact 28 can be disposed between a first pair of adjacent signal contacts 26 and a second pair of adjacent signal contacts 26.

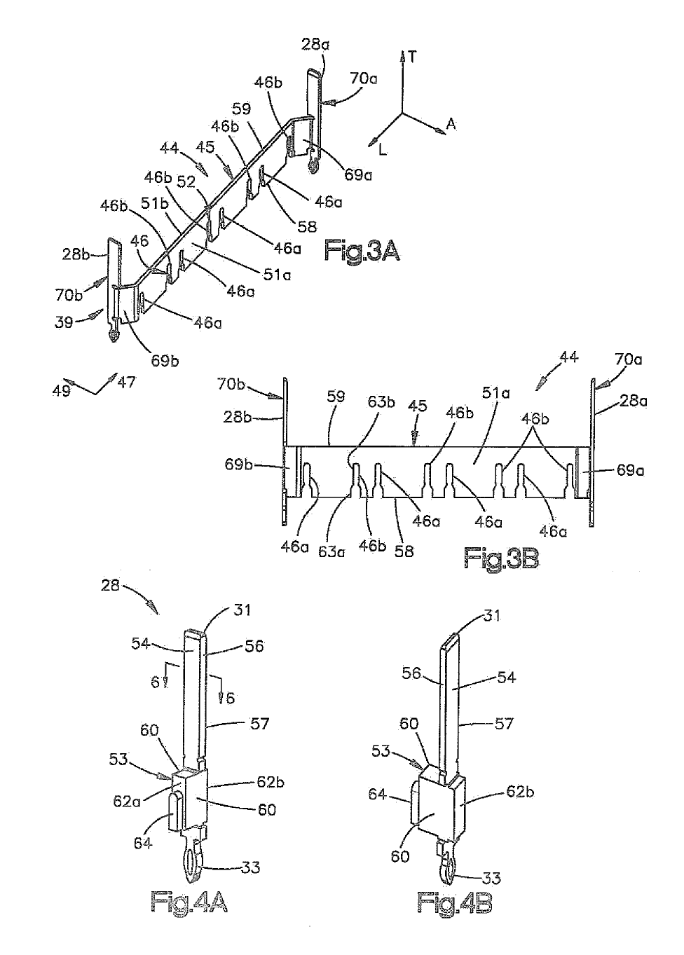

Referring also to FIGS. 4A-B and 6, each of the electrical contacts 38 can define respective first and second opposed broadsides 54 and first and second edges 56 connected between the broadsides. The edges 56 define a length less than that of the broadsides 56, such that the electrical contacts 38 define a substantially rectangular cross section. In accordance with the illustrated embodiment, the broadsides 54 extend longitudinally, or along a direction substantially parallel to the column 39. Thus, the edges 56 of adjacent electrical contacts 38, including adjacent signal contacts 26, can face each other along the respective column 39. Accordingly, when the adjacent signal contacts 26 define respective differential pairs, the adjacent signal contacts 26 can be referred to as edge-coupled signal contacts. Alternatively, the signal contacts 26 can be oriented such that the broadsides 54 of adjacent signal contacts 26 of a given differential pair face each other, such that the adjacent signal contacts 26 can alternatively be referred to as broadside-coupled signal contacts.

Referring now to FIGS. 2-4, the electrical connector 20 includes a plurality of ground contact networks 23 that each include respective electrically conductive ground coupling bars 44 that support at least one column 39 of respective ground contacts 28 spaced along the column direction 47. In accordance with the illustrated embodiment, each ground coupling bar 44 is configured to support first and second columns 39 of ground contacts 28. In accordance with the illustrated embodiment, each ground coupling bar 44 includes a body 45 that can be configured as a vertically oriented plate. The ground coupling bar bodies 45 can be made from any suitable electrically conductive material, such as a conductive plastic or metal. Each body 45 defines laterally opposed sides 51a-b that are configured to support respective ground contacts 28 that can be mounted onto the body 45 in respective adjacent columns 39 so as to place the ground contacts 28 that are mounted onto the body 45 in electrical communication with each other.

Each ground coupling bar 44 includes at least one such as a plurality of engagement members 52 that are configured to engage a complementary at least one such as a plurality of engagement member 53 of at least one such as a plurality of the ground contacts 28 so as to mount the ground contacts 28 onto the ground coupling bar 44. For instance, in accordance with the illustrated embodiment, the ground coupling bar 44 defines a first or lower end 58 and a second or upper end 59 that is spaced from the first or lower end 58 along the transverse direction T, such that the first or lower end 58 is more closely spaced to the mounting ends 33 of the ground contacts 28 than the second or upper end 59 when the ground contacts 28 are mounted to the ground coupling bar 44. Each of the ground coupling bars 44 define the engagement members 52 of the ground coupling bar 44 in the form of a plurality of slots 46 that extend up into the first or lower end 58 of the body 45 toward the second or upper end 59 and terminate short of the second or upper end 59. Alternatively, the slots 46 can extend down into the second or upper end 59 of the body 45 toward the first or lower end 58 and terminate short of the first or lower end 58. Thus, the slots 46 do not extend vertically through the body 45, but rather terminate in the body 45 and define mounting locations for the ground contacts 28. In accordance with the illustrated embodiment, each slot 46 defines a lead-in or a mouth 63a at a proximal open end of the slot 46 and a neck 63b that defines a distal terminal end of the slot 46. The neck 63b can define a lateral thickness less than that of the mouth 63a. Otherwise stated, the mouth 63a is wider than the neck 63b

The engagement member 53 of at least one such as a plurality of the ground contacts 28 can include a conductive mounting block 60 attached to the ground contact body 57. For instance, the mounting block 60 can be overmolded onto or otherwise discreetly attached to or integral with the contact body 57 as desired. Thus, the mounting block 60 can be made from any suitable conductive material, such as a conductive plastic, diecast or plated plastic, metal, conductive lossy material or the like. The mounting block 60 defines a first mounting surface 62a and a laterally opposed second surface 62b, and a mounting projection 64 that extends out from the first mounting surface 62a. In accordance with the illustrated embodiment, the mounting projections 64 extend out from the respective broadsides 54 in a direction substantially perpendicular to the broadsides 54 and parallel to the edges 56.

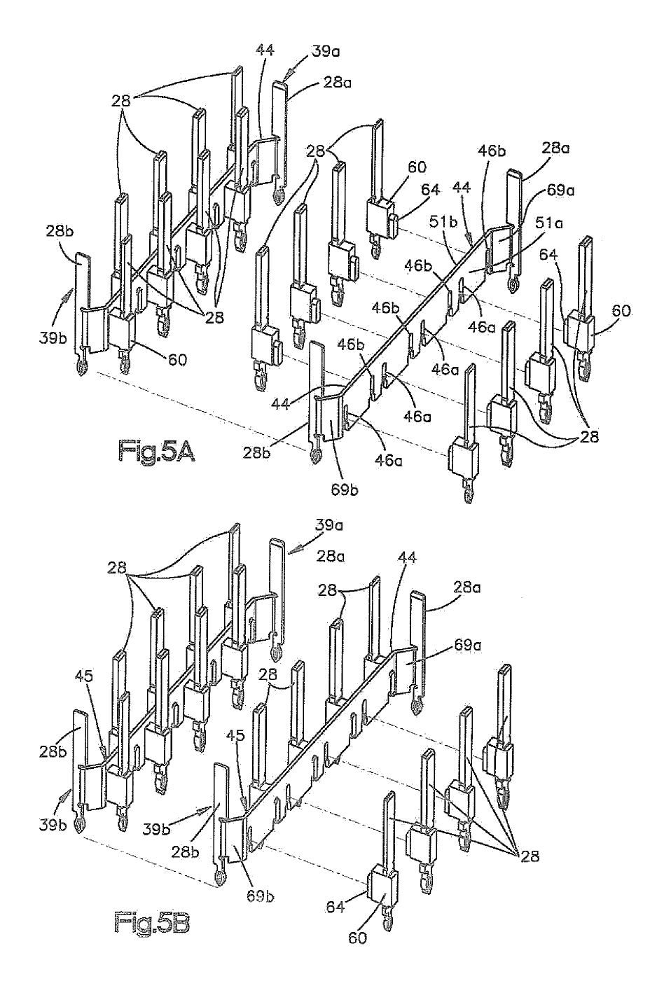

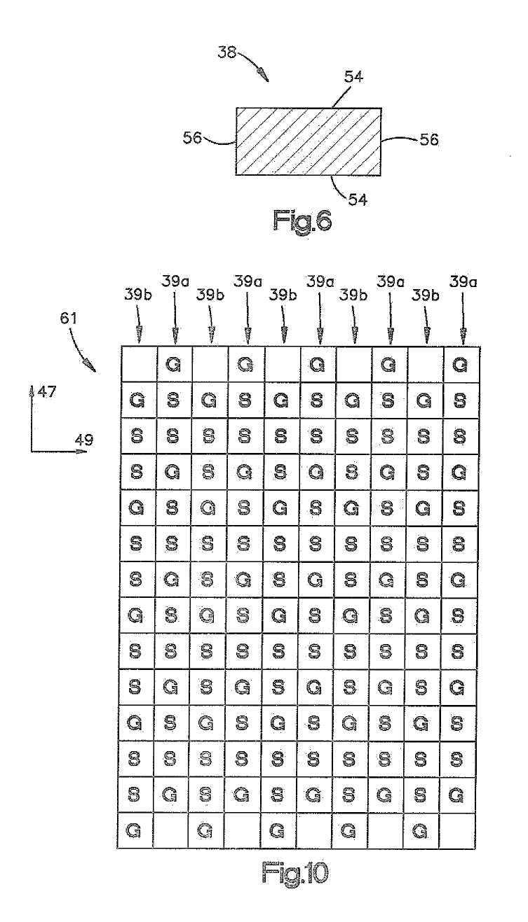

Referring also to FIGS. 5A-B, the mounting projections 64 define a lateral thickness substantially equal to that of the slot 46 such that the mounting projection 64 can be press-fit or otherwise inserted into respective slots 46 so as to mount the ground contacts 28 onto the ground coupling bar 45, such that the ground contacts 28 can be cantilevered from the ground coupling bar 45. For instance, the first surface 62a is attached to the ground coupling bar 45 while the contact body 57 and the second surface 62b are cantilevered from the ground coupling bar 45. The lateral thickness of the mounting projections 64 can be less than that of the mouth 63a but substantially equal to that of the neck 63b such that the mounting projections are press-fit in the necks 63b until the outer or upper edge of the mounting projections 64 abut the body 45 of the ground coupling bar 44 at the distal end of the slot 46.

The mounting projection 64 can extend out from the first mounting surface 62a any distance as desired, such that the first mounting surface 62 abuts a select one of the laterally opposed sides 51a-b of the ground coupling bar body 45. Accordingly, the first mounting surface 62a can extend substantially parallel to both the broadside 54 of the ground contacts 28 and the select one of the laterally opposed sides 51a-b. The broadsides 54 of the ground contacts 28 thus face the ground coupling bar 44 when the electrical contact 28 is mounted to the ground coupling bar 44. The edges 56 of the ground contacts 56 are thus also oriented substantially perpendicular to the ground coupling bar 44. Accordingly, the edges 56 of the ground contacts 28 face each other along the column direction 47 as well as the edges 56 of the adjacent signal contacts 26 when the ground contacts 28 are mounted to the ground coupling bar 44 and mounted to the connector housing 22. Alternatively, the ground contacts 28 can be oriented such that the broadsides 56 face each other and the broadsides 56 of the adjacent signal contacts 26.

Referring also again to FIG. 1, when the ground contacts 28 are mounted to the ground coupling bar 44, the center of the ground coupling bar 44 is spaced from the centerline C of the electrical contact 28 a distance substantially equal to one-half the row pitch RP. Thus, the mounting blocks 60 are sized so as to space the ground contacts 28 the same distance from the opposed first and second sides 51a-b. It should be appreciated that the engagement members 52 and 53 can be alternatively configured as desired so as to mount the ground contacts 28 onto the ground coupling bar 44. For instance, the engagement members 53 of the ground contacts 28 can be projections, and the engagement members 52 of the ground coupling bar 44 can be slots configured to receive the projections so as to mount the ground contacts 28 to the ground coupling bar 44. Alternatively or additionally, at least one or both of the engagement members 52 and 54 can include retention barbs (for instance, that project out from the projection and/or into the slot) that facilitate securement of the ground contacts 28 to the ground coupling bar 44. Alternatively or additionally still, one or more up to all the ground contacts 28 can be integral with the ground coupling bar 44. For instance, each ground contact network 23 can include one or more outer ground contacts 28a and 28b along the column direction 47 that are integrally connected to the ground coupling bar 44.

In accordance with the illustrated embodiment, a first at least one such as a plurality of ground contacts 28 is mounted to the first side 51a of the ground coupling bar 44 in the manner described above along a first column 39a, and a second at least one such as a second plurality of ground contacts 28 is mounted to the second side 51b of the ground coupling bar in the manner described above along a second column 39b. The ground coupling bar body 45, and thus the ground coupling bar 44, thus places the ground contacts 28 of each column 39a and 39b in electrical communication with each other along the respective column 39 or column direction 47, and further places the ground contacts 28 of the first column 39a in electrical communication with the ground contacts 28 of the second column 39b. Thus, the ground coupling bar 44 places the ground contacts 28 that are mounted to the ground coupling bar 44 in electrical communication both along the column direction 47 and the row direction 49. The electrical connector 20 can include a plurality of ground contact networks 23 so as to define a plurality of first and second columns 39a and 39b that are alternatingly arranged along the row direction 49.

In accordance with the illustrated, engagement members 52 or slots 46 of the ground coupling bar 44 are arranged as a first plurality of engagement members 52 such as a first plurality of slots 46a, such that the first plurality of ground contacts 28 of the first column 39a are mounted to the first plurality of engagement members 52 or slots 46a at the first side 51a, and a second plurality of engagement members 52 such as a second plurality of slots 46b, such that the second plurality of ground contacts 28 of the second column 39b are mounted to the second plurality of engagement members 52 or slots 46b at the second side 51b. Thus, a first at least one such as a plurality of ground contacts 28 can be attached in the first plurality of slots 46a, respectively, so as to mount the ground contacts 28 onto the first side 51a of the ground coupling bar 44, and a second at least one such as a plurality of ground contacts 28 can be attached in the second plurality of slots 46b, respectively, so as to mount the ground contacts 28 onto the second side 51b of the ground coupling bar 44. Adjacent slots 46 of the first plurality of slots 46a are spaced apart a distance that can be any multiple of the column pitch CP as desired such that at least one such as any desired number of signal contacts 26 can be disposed between adjacent ground contacts 28 along the column direction 47. For instance, adjacent slots 46 of the first plurality of slots 46a can be spaced apart a distance three times greater than the column pitch CP, such that a pair of signal contacts 26 can be disposed between the adjacent ground contacts 28.

Likewise, a second plurality of ground contacts 28 can be attached in the second plurality of slots 46b, respectively, so as to mount the ground contacts 28 onto the second side 51b of the ground coupling bar 44. The slots 46 of the second plurality of slots 46b are spaced apart a distance that can be any multiple of the column pitch CP as desired such that at least one such as any desired number of signal contacts 26 can be disposed between adjacent ground contacts 28 along the column direction 47. For instance, adjacent slots 46 of the second plurality of slots 46b can be spaced apart a distance three times greater than the column pitch CP, such that a pair of signal contacts 26 can be disposed between the adjacent ground contacts 28.

The mounting block 60 provides a stand-off along the row direction that spaces the respective ground contact 28 from the ground coupling bar 44. Accordingly, the ground contact networks 23 define gaps 81 disposed between adjacent ground contacts 28 along the column direction 47 that are configured to receive the signal contact 26 such that the signal contacts can be equidistantly spaced from the adjacent ground contacts 28, and can further be spaced from the ground coupling bar 44. Accordingly, the signal contacts 26 are positioned so as to be electrically isolated from the ground contacts 28 and the ground coupling bar 44. Furthermore, because the connector housing 22 is electrically insulative, the signal contacts 26 are electrically isolated from the ground contacts 28, while the ground contacts 28 of each ground contact network 23 are electrically commoned, or in electrical communication with each other, along the column direction 47 as well as along the row direction 49.

It should thus be appreciated that certain components of the electrical connector 20 can be electrically conductive so as to place the ground contacts 28 in electrical communication with each other, and certain components of the electrical connector 20 can be electrically insulative so as to electrically isolate the ground contacts 28 from the signal contacts 26, and further to electrically isolate the signal contacts 26 from each other as well as from the ground contacts 28. The electrically insulative components of the electrical connector 20, such as the support wall 50 alone or in addition to the remainder of the connector housing 22, can be wholly insulative or conductive with an insulative portion that isolates the electrical contacts 36 from each other when the electrical contacts 36 are mounted to the connector housing 22. The insulative portion can be made from any suitable insulating material, such as a plastic or nonconductive lossy material, such as an Eccosorb® material commercially available from Emerson & Cuming. As described above, the ground coupling bar 44, and in particular the ground coupling bar body 45, and a portion of the connector housing 22, can be made from any suitable conductive material, and for instance can be diecast or otherwise formed from any suitable conductive metal, made from any suitable conductive plastic or made from a conductive lossy material as desired. It should further be appreciated that a portion of the conductive ground coupling bar can be made from an electrically insulative material, and a portion of the ground coupling bar that is in contact with the ground contacts 28 can be made from an electrically conductive material. For instance, the conductive portion of the ground coupling bar 44 can be a layer disposed on or embedded in insulative material of the support wall ground coupling bar 44, alone or in combination with a conductive plating in the aperture in the ground coupling bar 44 that receives the ground contacts 28 and is electrically coupled to the layer so as to place the ground contacts 28 in electrical communication with each other.

Referring also to FIG. 10, the electrical contacts 38 are arranged in an array 61 having a footprint defined by the columns 39 including the first plurality of columns 39a and the second plurality of columns 39b that are disposed adjacent to each other along the row direction 49, such that the first and second pluralities of columns 39a and 39b are alternatingly arranged along the row direction 49. In accordance with the illustrated embodiment, the ground contacts 28 of each column 39 are arranged in a repeating S-S-G pattern along the column direction 47, such that the ground contacts 28 of at least one up to all of the plurality of first columns 39a can be longitudinally staggered or offset along the column direction 47 with respect to at least one up to all of the ground contacts 28 of the plurality of second columns 39b. Accordingly, at least a first column 39a, such as the plurality of first columns 39a, can define a repeating S-S-G pattern, while at least a second column 39, such as the plurality of second columns 39b, can define a repeating S-S-G pattern that is offset with respect to the first plurality of columns 39a by any distance as desired, such as the column pitch CP, or one or more electrical contacts 38. The electrical connector 20 can further include respective outer ground contacts 28a and 28b at each column 39 located longitudinally outward of the longitudinally outermost signal contact S.

For instance, at least one up to all of the ground coupling bars 44 can include first and second longitudinally opposed outer ends 69a-b, respectively, extend obliquely out from the respective ground coupling bar body along the column direction 47 and along the row direction 49 in opposite directions toward the respective columns 39a and 39b. Each outer end 69a and 69b can carry a respective outer ground contact 28a and 28b that are aligned with the respective ground contacts 28 of the columns 39a and 39b. For instance, referring again to FIGS. 2-4, the outer ground contacts 28a and 28b can be mounted to the outer ends 69a and 69b in any manner described above, and are integral with the outer ends 69a and 69b of the ground coupling bar in accordance with the illustrated embodiment. The outer ground contacts 28a and 28b can be oriented such that their opposed broadsides 54 are spaced from each other along the column direction 47. Accordingly the broadsides of the outer ground contacts 28a and 28b are oriented so as to face the edges 56 of the adjacent signal contacts 26 along the column direction.

Thus, each of the columns 39a and 39b can define first and second longitudinally opposed outer ends 70a and 70b. The outer ground contacts 28 of one of the first and second ends 70a-b of a select one of the first and second pluralities of columns 39a and 39b can be outwardly recessed with respect to the outer ground contact 28 of the other of the columns 39a and 39b along the column direction 47, while the outer ground contacts 28 of opposed outer end of the select one of the first and second pluralities of columns 39a and 39b is inwardly recessed with respect to the respective outer end of the other of the first and second pluralities of columns 39a and 39b along the column direction 47.

For instance, in accordance with the illustrated embodiment, the outer ground contact 28a of the first outer end 70a of each of the first plurality of columns 39a is outwardly recessed with respect to the outer ground contact 28a at the first outer end 70a of each of the second plurality of columns 39b, and the outer ground contact 28b at the second outer end 70b of each of the first plurality of columns 39a is inwardly recessed with respect to the outer ground contact 28b at the second outer end 70b of each of the second plurality of columns 39b.

It should thus be appreciated that while the ground contact networks 23 can define the same repeating S-S-G pattern of electrical contacts 38, the patterns can begin proximate to at opposite ends 70a and 70b of the respective columns 39a and 39b and extend in opposite directions along the respective columns 39a and 39b. Otherwise stated, the contact pattern of at least one first column 39a such as the first plurality of columns 39a along a first direction can be the same as the contact pattern of at least one second column 39b such as the second plurality of columns 39b along a second direction that is opposite the first direction. Alternatively, the first and second ground contact networks 23, and the first and second columns 39a-b, can define the same contact pattern along the same direction from the first outer end 70a to the second outer end 70b, or can define different contact patterns as desired. The electrical contacts 36 can define an pattern that is staggered from column to column, such that the columns 39a can define a repeating G-S-S-G-S-S pattern from the first outer end 70a along the column direction 47 toward the second outer end 70b, and the columns 39b can define a repeating S-S-G-S-S-G pattern from the first outer end 70a along the column direction 47 toward the second outer end 70b.

As described above, each of the first and second pluralities of columns 39a and 39b can be offset from each other along their respective column direction 47 by the column pitch CP. Accordingly, a select ground contact 28 such as each ground contact 28 of a respective column 39 is inline with a signal contact 26 of an immediately adjacent column 39 along the row direction 49. It should be appreciated, alternatively, that the columns 39a and 39b can alternatively be offset by any dimension as desired. Alternatively still, the columns 39a and 39b can be inline with each other, such that the signal contacts 26 of each column 39a and 39b are aligned along the row direction 49, and each of the ground contacts 28 of each column 39a and 39b are aligned along the row direction. While each of the first and second pluralities of column 39a and 39b defines the same repeating S-S-G pattern of signal contacts 26 and ground contacts 28 along the respective column 39, the columns can alternatively define different contact patterns as desired.

In accordance with the illustrated embodiment, at least one up to all of the first plurality of slots 46a are offset with respect to at least one up to all of the second plurality of slots 46b along the column direction 47. Accordingly, the first plurality of slots 46a are configured to receive the ground contacts 28 of the first column 39a, and the second plurality of slots 46b are configured to receive the ground contacts 28 of the second column 39b. Alternatively, the first and second slots 46a and 46b could be aligned along the row direction 49 such that the ground contacts 28 of the first and second columns 39a and 39b are inline with each other along the row direction. For instance the first slots 46a can extend into the first side 51a of the ground coupling bar 44, and the second slots 46b can extend into the second side 51b of the ground coupling bar 44.

It should thus be appreciated that each ground coupling bar 44 can support a first column 39a of electrical ground contacts 28 on one lateral side of the ground coupling bar 44, and a second column 30b of electrical ground contacts 28 on a laterally opposed side of the ground coupling bar 44. The ground coupling bars 44 can be laterally spaced along the connector housing base 34 such that the columns of ground contacts 28 are spaced laterally apart an equal distance. Because the ground coupling bar 44 is electrically conductive, all ground contacts 28 mounted onto a common ground coupling bar 44 are electrically commoned, or placed in electrical communication with each other.

Alternatively, each first and second laterally opposed side 51a and 51b of the ground coupling bar 44 can be electrically conductive, and the opposed lateral sides 51a and 51b are electrically insulated from each other such that the ground contacts 28 of each column 39 are electrically commoned, but insulated from the column of ground contacts 28 mounted onto the opposed lateral side of the ground coupling bar 44. Alternatively still, the ground contact networks 23 can be configured such that only one column of electrical ground contacts 28 is supported on each ground coupling bar 44.

Referring now again to FIGS. 1A-2, the support wall 50 supports the electrical contacts 38. In accordance with the illustrated embodiment, the support wall 50 directly supports the signal contacts 26 and the ground contacts 28 such that the signal and ground contacts 26 and 28 are in direct physical contact with the support wall 50. Alternatively, the support wall 50 can indirectly support the ground contacts 28. For instance, the support wall 50 can support the ground coupling bars 44, which in turn support the ground contacts 28. The support wall 50 is electrically insulative so as to prevent electrical signals from traveling across the electrical contacts 38 through the connector housing 22.

In accordance with the illustrated embodiment, the connector housing 22 defines a first plurality of apertures 80 and a second plurality of apertures 82 that extend through the support wall 50. The first plurality of apertures 80 are configured to receive the ground contacts 28 of the ground contact networks 23, and the second plurality of apertures 82 is configured to individually receive the corresponding signal contacts 26. The apertures 80 and 82 are spaced apart from each other along the column direction 47 and the row direction 49 so as to correspond positionally to the array 61 of electrical contacts 36.

For instance, each of the first and second pluralities of apertures 80 and 82 can be sized slightly less than or substantially equal to the cross-sectional dimension of the ground contacts 28 and signal contacts 26, respectively, such that the contacts 26 and 28 are press-fit in the support wall 50 inside the respective apertures 80 and 82. The first plurality of apertures 80 can be sized and shaped the same or differently than the second plurality of apertures 82 depending, for instance, on the corresponding size of the signal contacts 26 and ground contacts 28. For instance, the apertures 82 can be sized greater than the apertures 80, such that the apertures 80 and 82 are keyed to selectively accept the ground contacts 28 and signal contacts 26, respectively. For instance, the ground contacts 28 can be sized so as to fit in the apertures 82, but sized to be to fit in the apertures 80.

When the electrical contacts 38 are supported by the support wall 50, the respective mating ends 31 of the electrical contacts 38 extend above the support wall 50, and the mounting ends 33 are disposed below the support wall 50. The mating ends 31 of the ground contacts 28 can be inline with the mating ends 31 of the signal contacts 26, and the mounting ends 33 of the ground contacts 28 can be inline or offset with respect to the mounting ends 33 of the signal contacts 26. As described above, differential signal pairs 26′ can be disposed in the gaps 81 (see FIG. 2) disposed between adjacent ground contacts 28 along the column direction 47 when the electrical contacts 36 are mounted to the connector housing 22.

The ground contact networks 23, and thus the ground contacts 28, are mounted to the connector housing 22 by inserting the upper mating ends 31 of the respective ground contacts 28 up through the respective apertures 82 until the ground coupling bars 44 abut the lower end of the support wall 50, or can alternatively extend into respective slots formed in the lower end of the support wall 50, such that the ground contacts 28 are attached to the support wall 50 in the respective apertures 82. The signal contacts 28 are mounted to the connector housing 22 by inserting the upper mating ends 31 of the respective signal contacts 26 individually up through the respective apertures 80 such that the signal contacts 26 are press-fit in the apertures 80, such that the signal contacts 26 are attached to the support wall 50 in the respective apertures 80. The signal contacts 26 and/or the ground contacts 28 can include stops that abut the lower end of the support wall 50 when fully mounted to the connector housing 22.

The connector housing 22 can define slots 86 that extend from the bottom end 35b of the first and second end walls 32a and 32b up along the end walls 32a-b. For instance, the slots 86 can be aligned with, and sized to receive, the outer ground contacts 28a-b of the first and second pluralities of ground contact networks 23. Accordingly, a first plurality of slots 86 can extend into the first end wall 32a at locations adjacent the first outer end 70a of the first columns 39a and thus configured to receive outer ground contacts 28a, and a second plurality of slots 86 can extend into the second end wall 32b at locations adjacent the second outer end 70b of the second columns 39b and thus configured to receive outer ground contacts 28b. Accordingly, the slots 86 can define a lateral width substantially equal to the broadsides 54 of the respective outer ground contacts 28a-b, such that the broadsides 54 are recited in the slots 86 as the ground contact networks 23 are mounted to the connector housing 22.

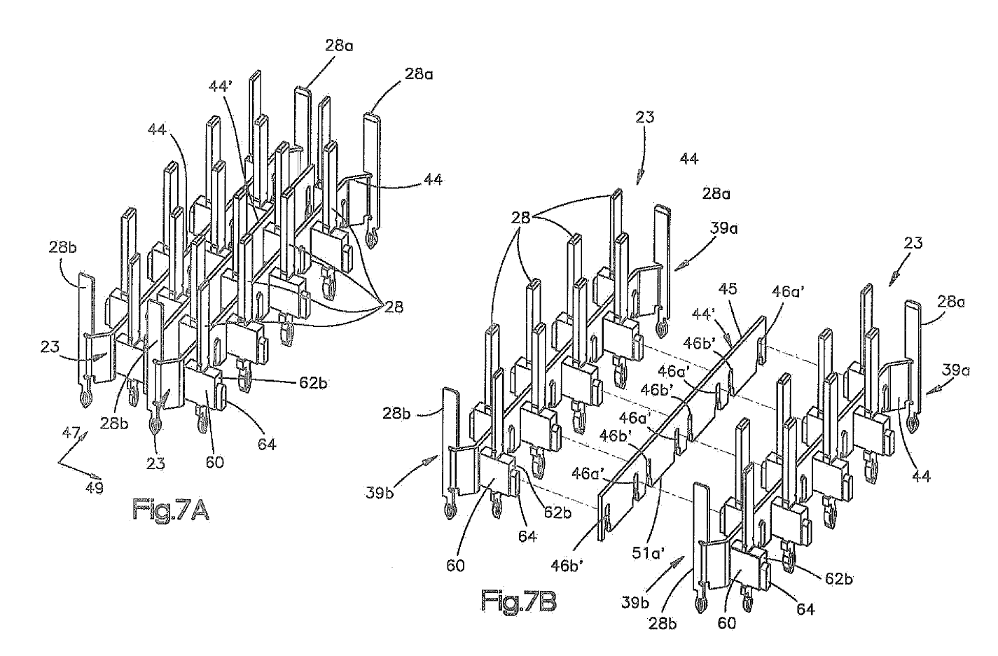

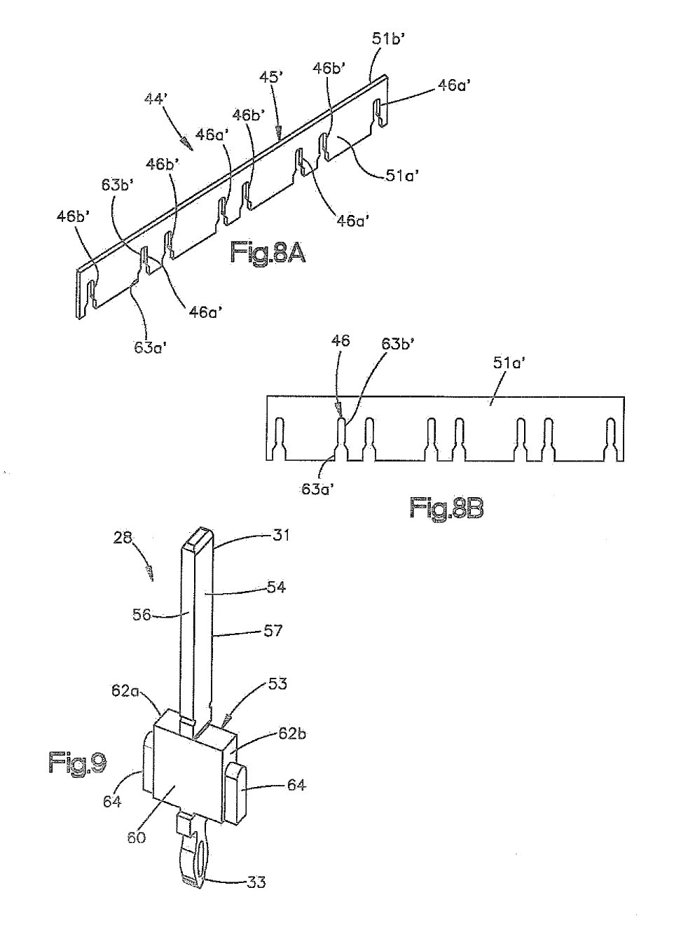

As described above, the ground contact networks 23 includes a first plurality of ground contacts 28 in electrical communication with each other along a first column 39a, and a second plurality of ground contacts 28 in electrical communication with each other along a second column 39b. Referring to FIGS. 7A-9, the electrical connector 20 can be further configured to place at least one such as a plurality of the ground contacts 28 of at least a first and a second ground contact network 23 such as a plurality of ground contact networks in electrical communication with each other. Thus, while a ground contact bar 44 places the ground contacts 28 of a pair of columns 39a and 39b in electrical communication, the electrical connector 20 is further configured to place the ground contacts 28 of a plurality greater than a pair of columns 39a and 39b in electrical communication with each other.

For instance, the electrical connector 20 can include at least one such as a plurality of auxiliary ground coupling bars 44′ that are configured to electrically connect to the second surfaces 62b of the ground contacts 28 of adjacent columns 39a and 39b of ground contacts 28 of a pair of adjacent ground contact networks 23 that are thus mounted to a pair of adjacent ground coupling bars 44. Thus, the ground coupling bars 44 can be referred to as primary ground coupling bars 44 that place first and second columns of ground contacts 28 in electrical communication, and the auxiliary ground coupling bars 44′ can electrically connect to at least one such as a plurality of ground contacts 28 of adjacent columns 39a and 39b that are mounted to a pair of adjacent primary ground coupling bars 44. The electrical connector can include as many auxiliary ground coupling bars 44′ as desired so as to place as many columns 39 of ground contacts 28 in electrical communication along the row direction 49 as desired. Thus, the auxiliary conductive ground coupling bar 44′ is connected to a first plurality of ground contacts of the first column 39a of a first one of a pair of ground contact networks 23 to a second plurality of ground contacts of the second column 39b of the other of the pair of ground contact networks 23.

For instance, each auxiliary ground coupling bar 44′ can be constructed as described above with respect to the primary ground coupling bars 44, however the auxiliary ground coupling bars 44′ can be devoid of the outer ends 69a-b. Thus, the auxiliary ground coupling bars 44′ can include at least one such as a plurality of engagement members 52 that are configured to engage a complementary at least one such as a plurality of engagement member 53 of at least one such as a plurality of the ground contacts 28 so as to mount the ground contacts 28 onto the auxiliary ground coupling bar 44a. For instance, in accordance with the illustrated embodiment, the auxiliary ground coupling bar 44′ defines a first or lower end 58′ and a second or upper end 59′ that is spaced from the first or lower end 58a along the transverse direction T, such that the first or lower end 58′ is more closely spaced to the mounting ends 33 of the ground contacts 28 than the second or upper end 59′ when the ground contacts 28 are mounted to the auxiliary ground coupling bar 44a. Each of the auxiliary ground coupling bars 44′ define the engagement members 52 of the auxiliary ground coupling bar 44′ in the form of a plurality of slots 46′ that extend up into the first or lower end 58′ of the auxiliary ground coupling bar body 45′ toward the second or upper end 59′ and terminate short of the second or upper end 59a. Alternatively, the slots 46′ can extend down into the second or upper end 59′ of the body 45′ toward the first or lower end 58′ and terminate short of the first or lower end 58a. Thus, the slots 46′ do not extend vertically through the body 45a, but rather terminate in the body 45′ and define mounting locations for the ground contacts 28. In accordance with the illustrated embodiment, each slot 46′ defines a mouth 63a′ at a proximal open end of the slot 46′ and a neck 63b′ that defines a distal terminal end of the slot 46′. The neck 63b′ can define a lateral thickness less than that of the mouth 63a′.

The engagement members 53 of the ground contacts 28 can include the conductive mounting block 60 as described above. Each of the mounting blocks 60 can further include a mounting projection 64a that extends out from the second mounting surface 62b and defines a lateral thickness substantially equal to that of the slots 46′ such that the mounting projections 64a can be press-fit or otherwise inserted into respective slots 46′ so as to mount the ground contacts 28 onto the auxiliary ground coupling bar 44′. Accordingly, the ground contacts 28 of adjacent ground contact networks 23 can be mounted onto the opposed sides of the auxiliary ground coupling bar 45′. The mounting projections 64a can be spaced from the centerline of the respective ground contacts 28 a distance substantially equal to the distance between the mounting projections and the centerline. Furthermore, the slots 46′ can include a first plurality of slots 46a′ and a second plurality of slots 46b′ as described above with respect to the primary ground coupling bar 44. Accordingly, the slots 46′ are aligned with the engagement members 53 or mounting projections 64a of the ground contacts 28. It should be appreciated that the auxiliary ground coupling bars 44′ can alternatively be mounted onto the ground contacts in any manner as desired.

The auxiliary ground coupling bar 44′ is electrically conductive, and can be made from any suitable electrically conductive material, such as a conductive plastic or metal. Accordingly, the auxiliary ground coupling bar 44′ establishes an electrical path between the ground contacts 28 mounted onto different primary ground coupling bars 44. As a result, one or more, up to all, of the ground contacts 28 can be placed in electrical communication regardless of whether they are mounted onto the same primary ground coupling bar 44.

Referring also to FIG. 10, the array 61 of electrical contacts 38 includes an array of ground contacts 28 spaced along the column direction 47 and the row direction 49, and an array of signal contacts 26 spaced along the column direction 47 and the row direction 49, such that select ground contacts 26 are disposed between select adjacent signal contacts 28. Otherwise stated, the array 61 of electrical contacts 38 is arranged in a plurality of columns 39 that extend along a respective column direction 47, wherein the columns 39 are spaced along a row direction 49 that extends substantially perpendicular to the column direction 47, and each of the columns 39 includes a plurality of signal contacts 26 and a plurality of ground contacts 28. The electrical connector 20 places the ground contacts 28 of the array 61 of electrical contacts 38 in electrical communication along the column direction 47, and can place the ground contacts 26 of at least a pair of adjacent columns 39a and 39b in electrical communication, while electrically isolating the signal contacts 26 of the array 61 of electrical contacts 38 from the ground contacts 28.

The electrical connector 20 can further electrically couple as many columns 39 of electrical contacts 26 as desired along the row direction 49, for instance by attaching the auxiliary ground coupling bars 44a to adjacent ground contact networks 23. Accordingly, it should be appreciated that the ground contacts 28 are electrically isolated from the plurality of signal contacts 26 along the respective column 39, and the plurality of ground contacts 28 of each column 39 are in electrical communication with each other and with the ground contacts 28 of the other columns 39. For instance, the ground contact networks 23 can include select ones of the array of signal contacts 26 and select ones of the array of ground contacts 28 of the array 61 of electrical contacts 38, such that the select ones of the ground contacts 26 are in electrical communication with each other.

The embodiments described in connection with the illustrated embodiments have been presented by way of illustration, and the present invention is therefore not intended to be limited to the disclosed embodiments. Furthermore, the structure and features of each the embodiments described above can be applied to the other embodiments described herein, unless otherwise indicated. Accordingly, those skilled in the art will realize that the invention is intended to encompass all modifications and alternative arrangements included within the spirit and scope of the invention, for instance as set forth by the appended claims.

What is claimed:

1. An electrical connector comprising:
an electrically insulative connector housing;
a plurality of signal contacts supported by the connector housing; and
a ground contact network including an electrically conductive ground coupling bar defining first and second opposed sides and a plurality of ground contacts mounted to each side of the ground coupling bar in first and second respective columns,
wherein the ground coupling bar places each of the plurality of ground contacts mounted to the first side in electrical communication with each other, further places each of the plurality of ground contacts mounted to the second side in electrical communication with each other, and further places each of the plurality of ground contacts mounted to the first side in electrical communication with each of the plurality of ground contacts mounted to the second side.

2. The electrical connector as recited in claim 1, wherein the plurality of ground contacts mounted to the first side of the ground coupling bar are spaced along a column direction, and the plurality of ground contacts mounted to the second side of the ground coupling bar are spaced along the column direction, and the plurality of ground contacts that are mounted to the first side of the ground coupling bar are offset with respect to the ground contacts that are mounted to the second side of the ground coupling bar along the column direction.

3. The electrical connector as recited in claim 2, wherein ground contact network defines a gap disposed between an adjacent pair of the plurality of ground contacts along the column direction that is configured to receive a pair of the signal contacts.

4. The electrical connector as recited in claim 3, wherein the pair of the signal contacts defines a differential signal pair.

5. The electrical connector as recited in claim 1, wherein the ground coupling bar comprises a body and a pair of opposed outer ends that extend obliquely from opposed ends of the body in opposite directions so as to define first and second outer ground contacts that are aligned with the first and second columns of ground contacts, respectively.

6. The electrical connector as recited in claim 5, wherein the plurality of ground contacts of the first and second columns define opposed edges and opposed broadsides that are longer than the edges, such that the edges of each of the plurality of ground contacts of the first and second columns, respectively, face each other.

7. The electrical connector as recited in claim 6, wherein the each of the outer ground contacts defines opposed edges and opposed broadsides that are longer than the edges, such that the broadsides of each of the outer contacts face the edge of an adjacent ground contact.

8. The electrical connector as recited in claim 1, wherein the ground coupling bar comprises a body and defines a plurality of slots extending into the body, and the ground contacts comprise a mounting projection that is press-fit in a respective one of the slots so as to mount the plurality of ground contacts to the ground coupling bar.

9. The electrical connector as recited in claim 1, wherein the ground contact network is a first ground contact network, and the electrical connector further comprises a second ground contact network and an auxiliary conductive ground coupling bar that electrically connects at least one ground contact of the first ground contact network with at least one ground contact of the second ground contact network.

10. The electrical connector as recited in claim 9, wherein the ground contacts each comprise a pair of mounting projections, a first one of the pair of mounting projections press-fit into a respective slot of the ground coupling bar and a second one of the pair of mounting projections press-fit into a respective slot of the auxiliary ground coupling bar.

11. An electrical connector comprising:
a connector housing;
a plurality of ground contacts and a plurality of signal contacts supported by the connector housing and spaced apart in a column direction and a row direction that is substantially perpendicular to the column direction; and
an electrically conductive ground coupling bar that is attached to select ones of the plurality of ground contacts so as to place the select ones of the plurality of ground contacts in electrical communication with each other along both the column direction and the row direction, wherein the ground contacts are electrically isolated from the signal contacts.

13. The electrical connector as recited in claim 11, wherein adjacent ones of the plurality of signal contacts along the column direction define a plurality of differential signal pairs

14. An electrical connector comprising:
an insulative connector housing supporting a plurality of signal contacts;
a pair of ground contact networks supported by the connector housing, each of the ground contact networks including 1) a conductive ground coupling bar that defines a first side and an opposed second side, and 2) a first plurality of ground contacts mounted to the first side and arranged in a first column, and a second plurality of ground contacts mounted to the second side and arranged in a second column.

15. The electrical connector as recited in claim 14, further comprising an auxiliary conductive ground coupling bar connected to the first plurality of ground contacts of one of the pair of ground contact networks, and further connected to the second plurality of ground contacts of the other of the pair of ground contact networks.
